(19) United States
(12) Patent Application Publication
(10) Pub. No.: US 2004/0016610 A1
(43) Pub. Date: Jan. 29, 2004

(54) Pad spring and disc brake incorporating a pad spring

(76) Inventor: Royston L. Morris, Rogerstone (GB)

Correspondence Address: CARLSON, GASKEY & OLDS, P.C., 400 WEST MAPLE ROAD, SUITE 350, BIRMINGHAM, MI, 48009, US

(21) Appl. No.: 10/607,427

(22) Filed: Jun. 26, 2003

(30) Foreign Application Priority Data
Jun. 26, 2002 (GB) 0214705.6

(51) Int. Cl. F16D 55/00

(52) U.S. Cl. 188/73.31

(57) ABSTRACT

A pad spring that fits on a brake carrier of a disc brake resiliently restrains one end of a disc brake pad in the carrier from movement in a radial direction. The pad spring has an abutment surface that supports one end of the pad and resiliently restraining movement thereof. The abutment surface is harder or softer than the backplate of the brake pad contacting the abutment surface to provide a wearing surface. The pad spring is configured to permit the brake disc pad to be mounted to the brake carrier in a radially inward direction while the disc brake in an assembled state.

### REFERENCE TO RELATED APPLICATIONS

The present invention claims priority to United Kingdom Patent Application No. 0214705.6, filed Jun. 26, 2002.

### TECHNICAL FIELD

The present invention relates to a pad spring and to a disc brake incorporating a pad spring. More particularly, the present invention relates to a pad spring that fits to a pad carrier of a disc brake.

### BACKGROUND OF THE INVENTION

Currently known disc brakes (shown in FIGS. 1 through 3) comprise a disc or rotor 20 mounted to a wheel hub for rotation with a vehicle wheel. A brake carrier 12, made from cast iron or steel, is fixed relative to the axis of rotation of the rotor 20 and is secured to a non-rotating portion of the vehicle (e.g. the vehicle suspension). A brake caliper comprising a bridge 16 secured to a housing 14 is slidably mounted on the carrier 12 to allow for movement parallel to the axis of rotation of the rotor 20. An actuator 18 communicates with one or more pistons or tappets (not shown) provided in housing 14 to apply the force required for the brake to function.

A pair of brake pads 22 comprising friction material 36 are mounted to a solid stamped, cut or cast iron or steel backplate 34 and are positioned either side of the rotor 20 with the friction material 36 facing the planar faces of the rotor 20. The backplates 34 of the pads 22 are seated on vertical and horizontal abutment regions 28 and 30, respectively, which are provided in openings 32 of the carrier 12 to restrain the pads 22 from rotational and inward radial movement, respectively. In a typical floating caliper type brake, one of the backplates 34 engages with the piston(s), either directly or via a spreader plate, to distribute the load. Braking is achieved when the actuator causes the piston(s) to push one of the pads 22 toward the rotor 20. Because the caliper is able to “float” on the carrier, this causes an equal frictional braking load to be applied by both pads 22.

Outward radial movement of the pads 22 is restricted by elongate pad springs 24, which seat in formations provided in the upper edge of the backplate and which are held down at their approximate center by a pad strap 26 that spans an opening between the bridge 16 and housing 14. The resilient restraint provided by the pad springs 24 limits the tendency of the pads 22 to rattle against the abutment regions 28 and 30 when a braking load is applied or when the vehicle is driving along an uneven surface. However, the restraint also permits axial movement of the pads 22 toward the rotor 20 during braking.

Despite the provision of pad springs 24, it has hitherto been preferable to harden and machine areas X of the regions 28 and 30 to limit damage that may be caused to the carrier 12 by repeated impacts of the backplate 34 therewith (due to vibrations caused by uneven road surfaces and the like in a primarily radial direction, and brake drag forces in a circumferential direction) that would otherwise shorten the service life of the carrier 12.

This need for machining and hardening, as well as the need to provide a pad strap 26 inevitably increases the cost of the overall disc brake assembly and results in a bulkier brake.

There is a desire for a brake assembly having a simplified structure and that minimizes damage to the carrier due to repeated contact with the backplate.

### SUMMARY OF THE INVENTION

One embodiment of the invention is directed to a pad spring that fits to a brake carrier of a disc brake and that is capable of resiliently restraining one end of a disc brake pad in the carrier from movement in a radial direction (e.g., radially outward and/or inward). The pad spring further comprises an abutment surface arranged so that it supports one end of the pad and restrains movement of the pad. The abutment surface has a different hardness (e.g., is harder or softer) than the hardness of a backplate of the brake pad that contacts the pad spring.

Another embodiment of the present invention is directed to a disc brake carrier assembly comprising a disc brake carrier and a disc brake pad retained in the disc brake carrier by two pad springs, said pad springs being capable of each restraining one end respectively of said disc brake pad in said carrier from movement in a radial direction. The pad springs have an abutment surface that is capable of supporting one end of the pad and restraining movement of the pad. The abutment surface has a different hardness than the backplate of the brake pad that contacts the pad spring.

The invention is also directed to a kit of parts comprising a disc brake pad and two pad springs having the characteristics described above.

Yet a further embodiment of the present invention is directed a pad spring that fits to a brake carrier of a disc brake comprising the carrier and a rotor. The pad spring resiliently restrains one end of a brake disc pad in the carrier from movement in a radial direction. The pad spring is configured to permit the brake disc pad to be mounted to the brake carrier in an inward radial direction with the pad spring fitted thereto while the disc brake in an assembled state.

Another embodiment of the present invention is a disc brake comprising a disc brake carrier, a rotor, and at least one disc brake pad retained in the carrier by two pad springs. The pad springs are capable of each restraining one end of the disc brake pad in said carrier to prevent movement of the brake pad in a radial direction. The pad springs may be configured in a brake pad subassembly comprising the disc brake pad and the pad springs. The subassembly can then be mounted to the brake carrier in a radially inward direction while the disc brake is in an assembled state.

A further embodiment of the present invention is directed to a method of fitting a disc brake pad to an assembled disc brake comprising a carrier and a rotor. The method comprises securing first and second pad springs to each end of the disc brake pad to form a brake pad subassembly, mounting the subassembly radially inwardly into the brake carrier, and securing the pad springs to the carrier to restrain the brake pad from movement in a radial direction relative to the carrier.

Other embodiments of the invention will be apparent from the description and claims below.

### BRIEF DESCRIPTION OF THE DRAWINGS

Embodiments of the present invention will now be described, by way of example only, with reference to the accompanying drawings in which:

FIG. 1 is a plan view of a prior art disc brake assembly;

FIG. 2 is a side elevation of the assembly of FIG. 1;

FIG. 3 is an exploded view of a portion of the carrier and one brake pad and a pad spring of FIGS. 1 and 2;

FIG. 4 is a plan view of a disc brake assembly incorporating a pad spring according to one embodiment of the present invention;

FIG. 5 is a side elevation of the assembly of FIG. 4;

FIG. 6 is an exploded view of a portion of the carrier, and one brake pad and pad spring of FIGS. 4 and 5;

FIG. 7 is a perspective view of the pad spring of FIG. 6;

FIG. 8 is an exploded view of a portion of a carrier and brake pad with a pad spring according to another embodiment of the present invention;

FIG. 9 is an exploded view of a portion of a carrier and brake pad with a pad spring according to a further embodiment of the present invention;

FIG. 10 is a perspective view of a component for use with another embodiment of the present invention;

FIG. 11 is an exploded view of a portion of a carrier and brake pad with a pad spring according to a yet another embodiment of the present invention;

FIG. 12 and FIG. 13a are views of a pad spring and pin according to a further embodiment of the present invention;

FIG. 13b is a pin according to another embodiment of the present invention;

FIG. 14 is an exploded perspective view of a portion of a carrier with a pad spring according to a further embodiment of the present invention;

FIG. 15 is an exploded perspective view of a portion of a carrier with a pad spring according to another embodiment of the present invention;

FIG. 16 is a plan view of a disc brake assembly incorporating pad springs according to a further embodiment of the present invention;

FIG. 17 is a side elevation of the assembly of FIG. 16; and

FIG. 18 is a perspective view of one of the pad springs shown in FIGS. 16 and 17.

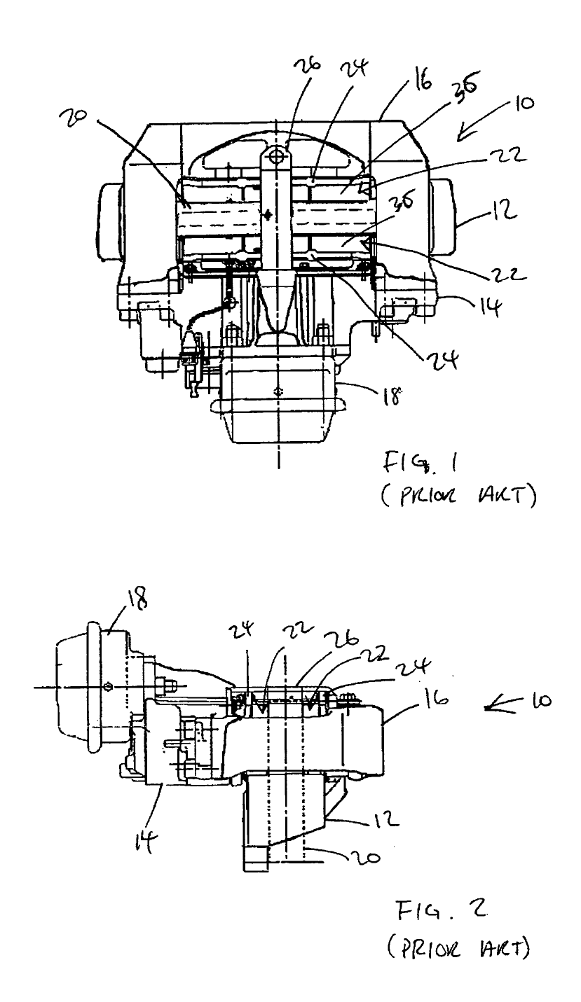

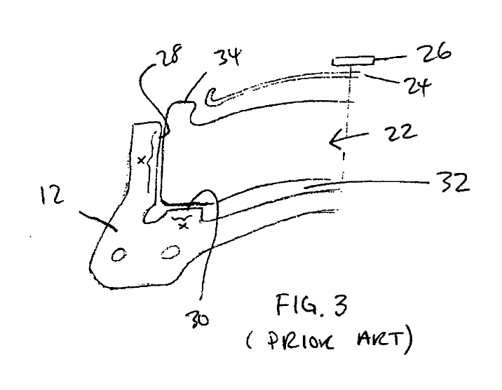

### DETAILED DESCRIPTION OF THE PREFERRED EMBODIMENTS

FIGS. 4, 5 and 6 illustrate a disc brake assembly 110 incorporating pad springs 138 according to one embodiment of the present invention. Where possible, like numerals have been used for equivalent parts to the prior art assembly with the addition of the prefix “I”.

It can be seen from FIGS. 4 and 5 that the conventional pad springs have been dispensed with and replaced by four pad springs 138 according to an embodiment of the present invention. Because the pad springs 138 are fitted at each end of the brake pads, the pad strap 26 of the prior art is unnecessary in the brake assembly. Other than the adaptations described herein for fitting the pad springs of the present invention, the brake pads, caliper, carrier and rotor used with the pad springs of the present invention are largely conventional.

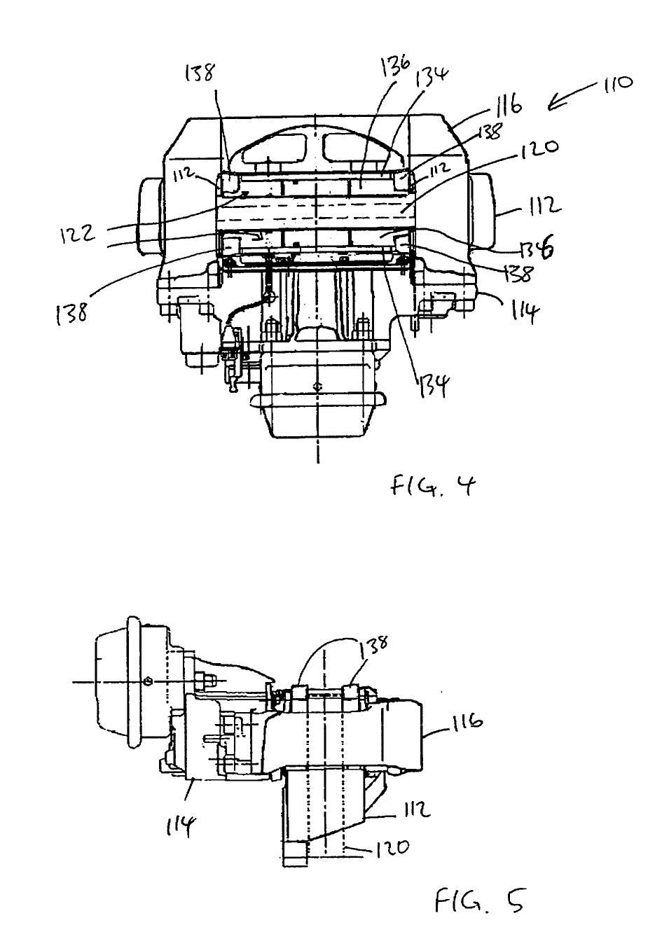

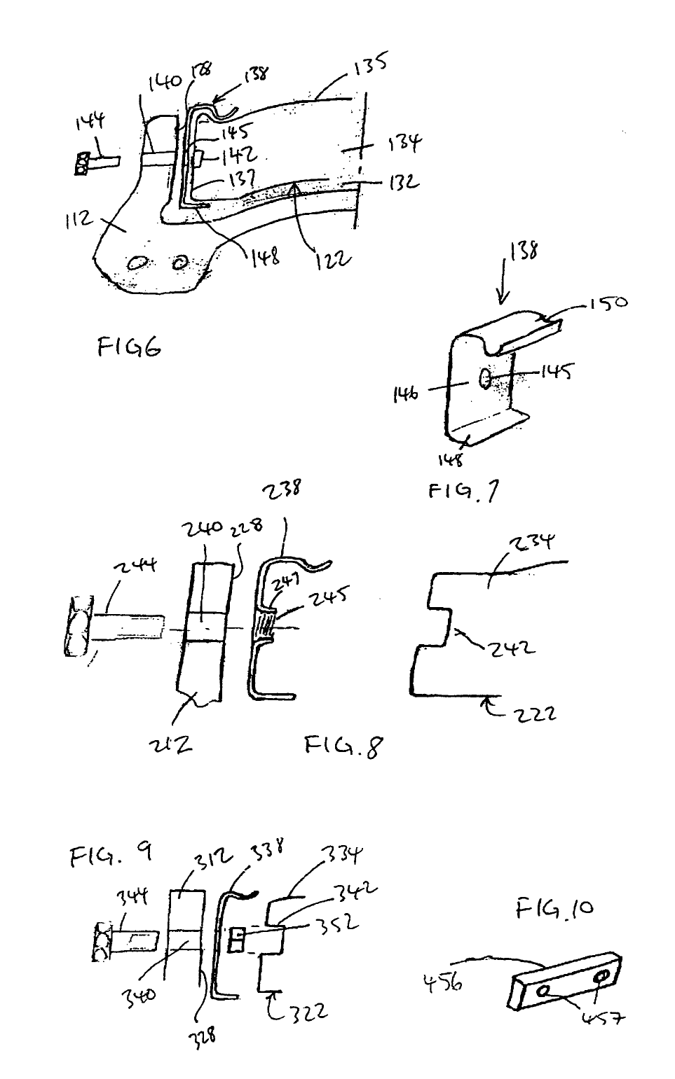

FIGS. 6 and 7 illustrate the shape of the pad springs 138 and the way they can be secured to the brake carrier 112. In this embodiment, the pad spring 138 comprises a vertical abutment surface 146 arranged to contact a corresponding vertical surface 128 of the carrier. The pad spring 138 also has a through bore 145. A horizontal pad support leg 148 extends from the lower edge of the vertical abutment surface 146 at substantially 90 degrees thereto, and a spring portion 150 of the pad spring extends from an upper edge of the vertical abutment surface 128 in substantially the same direction as the horizontal pad support leg 148. In this embodiment, the support leg 148 provides a cantilevered support of the lower edge of the pad. In other embodiments, the support leg 148 may act as an abutment surface disposed between the pad and a surface of the carrier. In this embodiment, the spring portion 150 has been formed to engage with a recess provided at one end of the upper face 135 of the backplate 134.

The pad springs 138 are preferably manufactured from spring steel or any other material having suitably resilient properties. It has been found that for the abutment and support surfaces to function effectively, the hardness of the material used for the pad springs 138 should be different (e.g., higher or lower) than the hardness of the brake pad backplate 134 material. In one embodiment, the abutment surface and support leg 146 and 148 may be made from an inherently tough or hard material (relative to the material of the backplate 134 of brake pad 112) and/or may be heat treated, induction treated or worked to impart the necessary toughness and/or hardness to withstand impact loads from the backplate 134 during use. Radial impact loads on the support leg 148 occur primarily due to vibration of the brake during vehicle motion. Circumferential loads occur primarily due to drag forces on the pad when the brake is applied. In this embodiment, the abutment surface 146 and support leg 148 are both harder than the backplate 134.

Alternatively, the vertical abutment surface 146 and the horizontal pad support leg 148 may be formed from a material that is inherently soft and malleable relative to the material properties of the backplate 134. In this case, the material in the abutment surface 146 and support leg 148 may be left untreated to simply act as sacrificial material that is replaced once its associated brake pad 122 is worn out and also replaced. In a preferred embodiment, the portions of the pad springs 138 are formed integrally from a single piece of material. The spring abutment and support surfaces 146 and 148 are preferably harder than the carrier and/or backplate in this embodiment. In one example, a suitable range of hardness in the abutment surface 146 and/or support leg 148 has been found to be 380 to 560 HB.

Each brake pad 122 is preferably fitted into the carrier 112 by first clipping the pad springs 138 to either end of the backplate 134 in the position shown in FIG. 6. The pads 122 and pad springs 138 are then slid into the openings 132 provided in the carrier 112 until the hole 145 in the spring 138 is aligned with a corresponding through bore 140 on the carrier. A fastener, such as a pin or attachment bolt 144, is then fitted through the bore 140 and hole 145 to secure the springs 138 in place. The bore 140 and/or hole 145 may be threaded to retain the spring 138 and hold the pad 122 in place more securely. As shown in FIG. 6, a cutaway or slot 142 may be provided in the end face pad 137 of the backplate 134 and friction material 136 to allow the pad 122 to slide forward and backward (when viewed in the direction shown in FIG. 6) to contact the rotor 120 of the brake assembly 110 during use.

It should be appreciated that, unlike prior art pad springs, the pad springs 138 of the present invention are fitted directly to the carrier 112 of a disc brake instead of being restrained by a pad strap that is in turn secured to the housing 114 and bridge 116 of the brake. It should also be appreciated that the width of the pad springs 138 should be sufficient to retain the pads 122 throughout the entire extent of their travel towards the rotor 120 as the friction material in the pads 122 is progressively worn away.

The interaction of the support leg 148 with the spring portion 150 of the pad spring 138 achieves the same or similar resilient pad retaining effect as prior art pad spring and strap arrangements. It should further be appreciated that the arrangement shown in FIG. 6 permits the pad 122 to be replaced while the brake assembly 110 remains fitted to the vehicle because the opening 132 in the carrier 112 and the outer opening of the bore 140 on the carrier 112 is normally accessible even when the brake assembly 110 is still fitted on the vehicle.

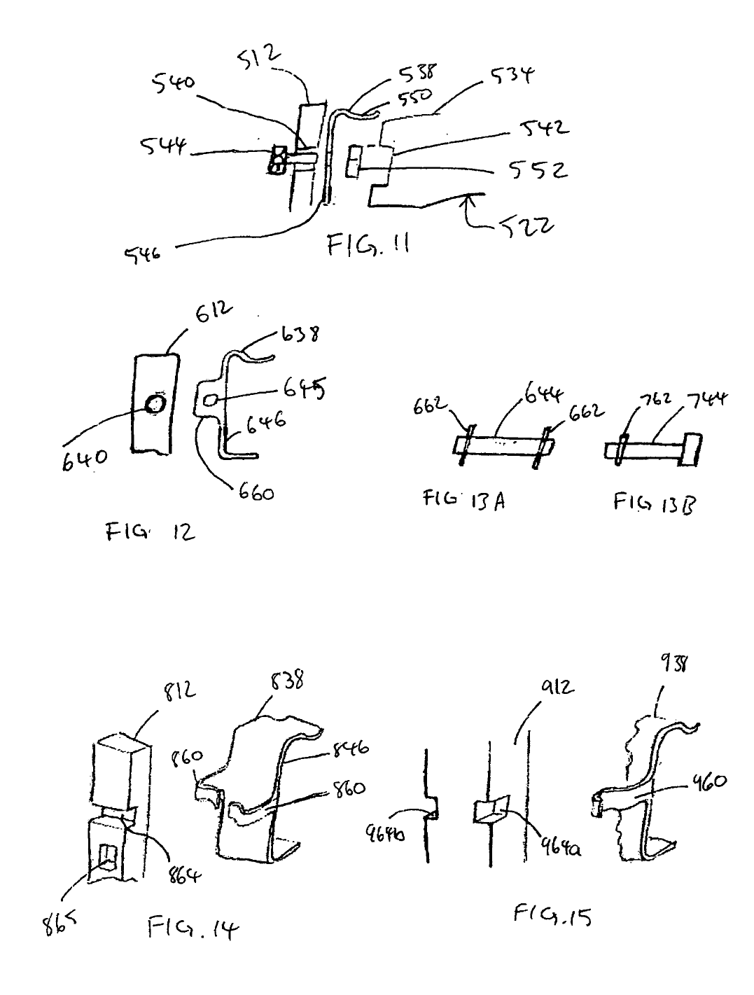

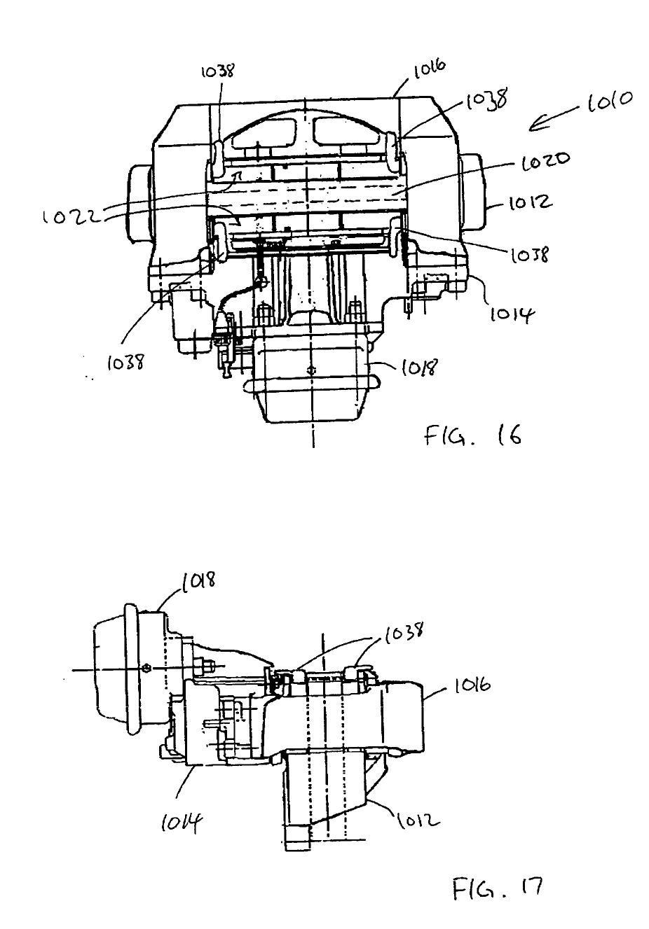

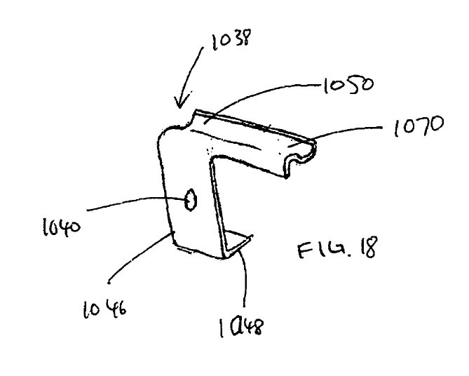

FIG. 8 shows a pad spring according to another embodiment of the present invention with like parts being designated by like numerals with the addition of the prefix “2”. In this embodiment, the through hole 245 has been formed with a lip 247 turned toward the backplate 234. The lip 247 may be threaded using a swaging process or the like, thereby providing a greater amount of threaded area on the spring to achieve a more secure connection to the carrier 212. Again, a slot 242 is provided in the pad 222 to accommodate the bolt 244 and lip 247. As an alternative, the lip 247 may be turned away from the backplate 234, with a vertical slot being provided in the carrier 212 to enable the spring 238 to be slid in vertically, thereby negating the need for a slot 242 in the pad 222.

FIG. 9 illustrates a third embodiment of the present invention in which like parts are again designated by like numerals but with the prefix “3”. In this embodiment, a retention piece, such as a nut 352, is used in conjunction with a fastener 344 to secure the spring 338 to the carrier 312. To simplify the fitting procedure, the slot 342 is preferably dimensioned to prevent rotation of the nut as it is secured to the bolt 344 while still permitting sliding movement of pads 322 towards the rotor while fitted in the brake assembly.

An alternative to the nut 352 is illustrated in FIG. 10. In this embodiment, two through bores (not shown) are provided in the carrier through which two bolts are fitted. A plate 456 having two threaded apertures 457 that are mutually spaced by the same distance as the through bores on the carrier acts as the retention piece, replacing the two nuts that would otherwise secure the spring to the carrier.

FIG. 11 illustrates an embodiment of the pad spring where the pad support leg has been omitted. In this embodiment, a nut 552 or a nut plate similar to that of FIG. 10 is used to resist inward radial movement of the pad 522 due to engagement of the nut or nut plate 552 in the slot 542 of the pad 522.

FIGS. 12, 13A and 13B illustrate yet another an alternative securement arrangement of the spring 638 in which like parts are designated by like numerals with the addition of the prefix “6”. In this embodiment, the through bore 640 extends along an axis perpendicular to the plane of the paper. The pad spring 638 has a pair of holes 645 corresponding to the through bore 640 and that are disposed on a pair of wings 660 extending toward the carrier 612 from vertical edges of the vertical abutment surface 646. The carrier 612 and spring 638 are then secured together by a pin 644, as shown in FIG. 13A, with axial movement thereof being restricted by a pair of clips 662. Alternatively, the through bore 640 may be threaded and the bolt 744 shown in FIG. 13B is used in conjunction with a clip 762 to prevent the bolt 744 from working loose.

FIGS. 14 and 15 illustrate eighth and ninth embodiments of the present invention respectively. In these embodiments, the pad springs 838 and 938 have a pair of resilient spring legs 860, 960 extending from the clip to engage with either slot 864, recess 865 (shown for convenience on the same Figure as slot 864) or cut-outs 964a and 964b to clip the pad springs 838, 938 into place on the carrier 812 and 912. This structure eliminates the need to have a spanner or the like for fitting. To make fitting the pad springs 838, 938 easier, the upper end of the carrier 812, 912 may be tapered such that the spring legs 860, 960 slide easily onto the carrier.

A tenth embodiment of the present invention is shown in FIGS. 16, 17 and 18. In this embodiment, the springs 1038 are fitted at each end of a pad 1022, but the spring portion 1050 comprises an extension 1070. As shown in FIGS. 16 and 17, the extension 1070 is arranged to extend over the bridge 1016 and/or housing 1014 of the brake. The bridge 1016 and housing 1014 are thereby resiliently loaded against the carrier 1012. This minimizes any rattling of the bridge and housing that may occur due to play in the slidable mounting of the bridge/housing 1016/1014 on the carrier 1012.

It is apparent that the pad springs of the present invention have a number of advantages over prior art springs. For example, the invention eliminates the need for hardening of carrier abutments because impact loading of the brake pads is taken by the abutment and/or support surfaces of the pad spring rather than the carrier directly. Also, the spring element is self-contained in the pad support, eliminating the need for a separate structure for retaining the pads. Furthermore, by eliminating the retaining pad strap and bolt, more clearance between the brake and wheel is created, potentially allowing more material to be added to the casting for the bridge and thereby permitting the brake to be strengthened. In addition, the pad springs enable brake pads to be fitted and removed in a radial direction while the brake is assembled, particularly while the caliper is assembled to the carrier. This makes brake servicing easier.

It should be appreciated that the various terms used to describe the orientation of the various components has been used for convenience and ease of explanation, and that brakes incorporating springs according to the present invention may be fitted in numerous orientations on a particular vehicle. It must also be appreciated that numerous changes may be made within the scope of the present invention. For example, the extended spring portion may be applied to springs having any one of the various means of attachment disclosed in the preceding embodiments and a variety of the features such as the removal of the support leg may be combined with features of the other embodiments. Furthermore, the pad spring may be used in conjunction with a standard pad spring to retain brake pads in a radially inward direction only and not a radially outward direction. An advantage of this configuration is that it may protect the abutment regions of the brake carrier, thereby potentially negating the need for these regions to be hardened, and thus potentially reducing manufacturing costs, and/or extending the service life of the carrier.

It should be understood that various alternatives to the embodiments of the invention described herein may be employed in practicing the invention. It is intended that the following claims define the scope of the invention and that the method and apparatus within the scope of these claims and their equivalents be covered thereby.

1. A pad spring for supporting a brake pad in a brake assembly having a carrier and a backplate supporting the brake pad, the pad spring comprising:
a spring portion that engages an outer face of the backplate to resiliently restrain an end of the brake pad from radial movement relative to the carrier; and
an abutment surface to be disposed between the brake pad and the carrier, wherein the abutment surface has a different hardness than the backplate.

2. The pad spring of claim 1, wherein the pad spring restrains the brake pad from at least one of inward radial movement, outward radial movement, and circumferential movement.

3. The pad spring of claim 1, further comprising at least one clip extending from the abutment surface, wherein said at least one clip is securable to the carrier.

4. The pad spring of claim 3, wherein said at least one clip comprises two clips integrally formed with the abutment surface.

5. The pad spring of claim 3, further comprising at least one resilient spring leg extending from said at least one clip to secure the pad spring to the carrier.

6. The pad spring of claim 3, wherein said at least one clip includes at least one hole to accommodate a fastener.

7. The pad spring of claim 1, further comprising a pad support leg that restricts inward radial movement of the brake pad with respect to the carrier.

8. The pad spring of claim 7, wherein the pad support leg is substantially parallel to the spring portion.

9. The pad spring of claim 7, wherein the spring portion and the pad support leg extend from the abutment surface at substantially right angles with respect to the abutment surface.

10. The pad spring of claim 1, further comprising a through hole in the abutment surface to accommodate a fastener.

11. The pad spring of claim 10, further comprising a lip surrounding the through hole.

12. The pad spring of claim 1, further comprising an extension that extends from the spring portion.

13. A disc brake carrier assembly, comprising:
a carrier;
a brake pad disposed in the carrier;
a backplate supporting the brake pad; and
at least two pad springs that hold the brake pad in the carrier, each of said pad springs comprising
a spring portion that engages an outer face of the backplate to resiliently restrain an end of the brake pad from radial movement relative to the carrier, and
an abutment surface disposed between the brake pad and the carrier, wherein the abutment surface has a different hardness than the backplate.

14. The disc brake carrier assembly of claim 13, wherein the pad spring restrains the brake pad from at least one of inward radial movement, outward radial movement, and circumferential movement.

15. The disc brake carrier assembly of claim 13, wherein said at least two pad springs further comprise at least one clip integrally formed with the abutment surface.

16. The disc brake carrier assembly of claim 15, further comprising a resilient spring leg extending from each clip to secure the pad spring to the carrier, wherein the carrier has at least one recess to engage with the resilient spring leg.

17. The disc brake carrier assembly of claim 15, further comprising a fastener extending through said at least one clip and the carrier.

18. The disc brake carrier assembly of claim 13, further comprising a pad support leg that restricts inward radial movement of the brake pad with respect to the carrier.

19. The disc brake carrier assembly of claim 18, wherein the spring portion and the pad support leg extend from the abutment surface at substantially right angles with respect to the abutment surface.

20. The disc brake carrier assembly of claim 13, further comprising at least one fastener extending through at least one pad spring and the carrier.

21. The disc brake carrier assembly of claim 20, wherein the pad spring further comprises a threaded lip forming a bore, wherein the fastener is a threaded fastener extending through the bore.

22. The disc brake carrier assembly of claim 20, further comprising a retention piece disposed between the pad spring and the brake pad, wherein said at least one fastener extends through the retention piece.

23. The disc brake carrier assembly of claim 20, wherein an end portion of the brake pad has a cutaway to accommodate the fastener.

24. The disc brake carrier assembly of claim 13, wherein the brake pad is slidable in a direction substantially perpendicular to a plane of a friction surface on the brake pad.

25. The disc brake carrier assembly of claim 13, wherein the pad spring further comprises an extension that extends from the spring position.

26. A pad spring for fitment to a brake carrier of a disc brake comprising the carrier and a rotor so as to be capable of resiliently restraining one end of a brake disc pad in the carrier from movement in a radially outward and/or inward direction, said pad spring being configured to permit the brake disc pad to be mounted to the brake carrier in a radially inward direction with said pad spring fitted thereto and whilst the disc brake in an assembled state.

27. A kit for a brake assembly, comprising:
a brake pad;
a backplate supporting the brake pad; and
two pad springs that support the brake pad in a carrier of a brake assembly, each pad spring comprising
a spring portion that engages an outer face of the backplate to resiliently restrain an end of the brake pad from radial movement relative to the carrier, and
an abutment surface to be disposed between the brake pad and the carrier, wherein the abutment surface has a different hardness than the backplate.

28. A disc brake, comprising:
a carrier;
a rotor;
a pair of brake pads disposed in the carrier on either side of the rotor;
a backplate supporting each brake pad; and
at least two pad springs that hold the brake pad in the carrier, each of said pad springs comprising
a spring portion that engages an outer face of the backplate to resiliently restrain an end of the brake pad from radial movement relative to the carrier;
an abutment surface disposed between the brake pad and the carrier, wherein the abutment surface has a different hardness than the backplate.

29. A method of fitting a disc brake pad to an assembled disc brake comprising a carrier and a rotor, comprising:
securing first and second pad springs to each end of the disc brake pad to form a brake pad subassembly;
mounting the subassembly radially inwardly into a carrier in the assembled disc brake; and
securing the pad springs to the carrier to restrain the brake pad from radial movement relative to the carrier.
